(19) United States
(12) Patent Application Publication
(10) Pub. No.: US 2014/0012983 A1
(43) Pub. Date: Jan. 9, 2014

(54) System and Method for Providing Operational Intelligence for Managed Devices

(71) Applicant: OpenPeak Inc., Boca Raton, FL (US)

(72) Inventors: John R. Brown, Boynton Beach, FL (US); Andy A. Aiello, Boca Raton, FL (US); Robert M. Dare, Sunrise, FL (US)

(21) Appl. No.: 13/906,503

(22) Filed: May 31, 2013

Related U.S. Application Data
(60) Provisional application No. 61/653,741, filed on May 31, 2012.

(51) Int. Cl. H04L 12/26

(52) U.S. Cl. CPC H04L 43/08
USPC 709/224

(57) ABSTRACT

A system and method for providing operational intelligence for managed devices are described herein. The method can include the step of receiving operational reports from a plurality of managed devices in which the managed devices include devices that have different operating environments and the step of analyzing the operational reports. Based on the analysis of the operational reports, one or more operational issues associated with a subset of the plurality of managed devices can be detected. In addition, corrective action can be taken in response to the detected operational issues.

This patent application claims priority to U.S. provisional patent application No. 61/653,741, filed on May 31, 2012, which is incorporated herein by reference in its entirety.

### FIELD OF TECHNOLOGY

The present subject matter relates to systems and methods for providing operational information for managed computing devices.

### BACKGROUND

Recently, there has been a movement towards managed mobile devices. In such a configuration, an enterprise may wish to maintain some control over the content on an employee's mobile device, in addition to the operation of the device. For example, OpenPeak Inc. of Boca Raton, Fla. has developed solutions that enable an enterprise to provision a mobile device with bundles that contain approved content—like policies and applications. These solutions also allow the enterprise to control certain functions or features of the managed device, such as wiping data or selectively disabling certain hardware components. With these comprehensive management processes, there is a need to provide analytics associated with the operation of multiple managed devices for the purpose of improving such processes.

### SUMMARY

A method for providing operational intelligence for managed devices is described herein. The method can include the step of receiving operational reports from a plurality of managed devices in which the managed devices can include devices that have different operating environments. The method can also include the steps of analyzing the operational reports and, based on the analysis of the operational reports, detecting one or more operational issues associated with a subset of the plurality of managed devices. Corrective action can also be taken in response to the detected operational issues.

As an example, detecting one or more operational issues can include detecting currently existing operational issues or detecting operational issues that have a probability of existing at a future time. As another example, the operational issue can be a degradation in the performance of the subset of managed devices.

In one arrangement, taking corrective action may include reporting the detected operational issues or responding to the detected operational issues by executing one or more corrective steps. Reporting the detected operational issues may include the following examples: (1) reporting a data usage limit associated with the operation of the subset of managed devices; (2) reporting network connection events associated with the operation of the subset of managed devices; (3) reporting a recommended shift in network assignments for the subset of managed devices; (4) reporting a predicted impact on the operation of the subset of managed devices if a predetermined course of action is to be followed; or (5) reporting a root cause analysis that identifies one or more problems, configurations or events as the root cause of the detected operational issues. Executing one or more corrective steps may include the following examples: (1) directing one or more of the subset of managed devices to revert back to a previous configuration; (2) provisioning one or more of the subset of managed devices with an upgrade to an operational plan; (3) directing one or more of the subset of managed devices to shift from a first network to a second network or to shift from a first portion of the first network to a second portion of the first network; (4) restricting the operation of a hardware or software component of one or more of the subset of managed devices; or (5) directing another party to execute one or more corrective steps.

The method may also include the steps of identifying a plurality of configuration dimensions associated with the plurality of managed devices and selecting a subset of the configuration dimensions such that the received operational reports are based on the selected subset of configuration dimensions. The configuration dimensions may be based on the following examples: (1) content installed on the plurality of managed devices; (2) device types of the plurality of managed devices; (3) hardware or software configurations of the plurality of managed devices; (4) a network connection of the plurality of managed devices; or (5) a location of the plurality of managed devices. The method can also include the step of translating information from the operational reports from one form into another based on an enterprise that is to receive the information from the operational reports.

In one embodiment, receiving operational reports from the plurality of managed devices can include receiving the operational reports based on a predetermined schedule or a predetermined event. As an example, the predetermined event can be a managed device being connected to a predetermined network, the managed device powering up or the managed device entering a predetermined location.

Another method for providing operational intelligence for managed devices is described herein. The method can include the step of identifying a plurality of managed devices that are associated with an enterprise in which at least some of the managed devices are configured with different operating environments and the step of receiving operational reports from the managed devices. The method can also include the steps of analyzing the operational reports and—based on the analysis of the operational reports—detecting one or more operational issues associated with a subset of the plurality of managed devices. The operational issues may also be reported to the enterprise. This method can also include the steps of identifying a plurality of configuration dimensions associated with the plurality of managed devices and selecting a subset of the configuration dimensions such that the received operational reports are based on the selected subset of configuration dimensions. In this case, the reported operational issues are related to the selected subset of configuration dimensions.

Yet another method for providing operational intelligence for managed devices is described herein. This method can include the step of identifying a plurality of managed devices in which at least some of the managed devices are configured with different operating environments and the step of receiving operational reports from the managed devices. The method can also include the steps of analyzing the operational reports and based on the analysis of the operational reports, detecting one or more operational issues associated with a subset of the plurality of managed devices. The detected operational issues can be responded to by executing one or more corrective steps.

In one arrangement, the managed devices here may be associated with an enterprise, and the method can further include reporting the operational issues and the corrective steps to the enterprise. Moreover, permission from the enterprise can be received prior to executing the corrective steps. This method can also include the steps of identifying a plurality of configuration dimensions associated with the plurality of managed devices and selecting a subset of the configuration dimensions such that the received operational reports are based on the selected subset of configuration dimensions. The reported operational issues may be related to the selected subset of configuration dimensions.

Yet another method of receiving operational intelligence for managed devices is described herein. This method can include the step of receiving a report of operational issues associated with a subset of a plurality of managed devices in which at least some of the managed devices are configured with different operating environments. In response to the report of operational issues, one or more corrective steps can be executed to resolve the operational issues associated with the subset of managed devices or instructions can be provided to a party to execute one or more corrective steps to resolve the operational issues. The managed devices may be associated with an enterprise, and the enterprise and the party may be separate entities. In one arrangement, executing one or more corrective steps in this method may include the following examples: (1) directing one or more of the subset of managed devices to revert back to a previous configuration; (2) provisioning one or more of the subset of managed devices with an upgrade of an operational plan; (3) directing one or more of the subset of managed devices to shift from a first network to a second network or to shift from a first portion of the first network to a second portion of the first network; or (4) restricting the operation of a hardware or software component of one or more of the subset of managed devices.

A system for providing operational intelligence for managed devices is also described herein. The system can include an interface in which the interface may be configured to receive operational reports from a plurality of managed devices. At least some of the managed devices may be configured with different operating environments. The system can also include an analysis module that can be communicatively coupled to the interface. The analysis module can be configured to analyze the operational reports and based on the analysis of the operational reports, detect one or more operational issues associated with a subset of the plurality of managed devices. The analysis module can also be configured to report the operational issues to one or more authorized parties.

The system can also include a management module in which the management module can be configured to execute one or more corrective steps in response to the reported operational issues. Moreover, the operational issues that are detected may be currently existing operational issues or operational issues that have a probability of existing at a future time. As an example, the operational issue can be a degradation in the performance of the subset of managed devices.

In one arrangement, the analysis module can be further configured to report the operational issues by any of the following: (1) reporting a data usage limit associated with the operation of the subset of managed devices; (2) reporting network connection events associated with the operation of the subset of managed devices; (3) reporting a recommended shift in network assignments for the subset of managed devices; (4) reporting a predicted impact on the operation of the subset of managed devices if a predetermined course of action is to be followed; or (5) reporting a root cause analysis that identifies one or more problems, configurations or events as the root cause of the detected operational issues. In another arrangement, the management module can be further configured to execute the corrective steps by any of the following: (1) directing one or more of the subset of managed devices to revert back to a previous configuration; (2) provisioning one or more of the subset of managed devices with an upgrade to an operational plan; (3) directing one or more of the subset of managed devices to shift from a first network to a second network or to shift from a first portion of the first network to a second portion of the first network; (4) restricting the operation of a hardware or software component of one or more of the subset of managed devices; or (5) directing another party to execute one or more corrective steps.

In another arrangement, the analysis module can be further configured to identify a plurality of configuration dimensions associated with the plurality of managed devices and select a subset of the configuration dimensions such that the received operational reports are based on the selected subset of configuration dimensions. As an example, the configuration dimensions may be based on any of the following: (1) content installed on the plurality of managed devices; (2) device types of the plurality of managed devices; (3) hardware or software configurations of the plurality of managed devices; (4) a network connection of the plurality of managed devices or a location of the plurality of managed devices.

In one embodiment, the operational reports may be received from the managed devices based on a predetermined schedule or a predetermined event. As an example, the predetermined event can be a managed device being connected to a predetermined network, the managed device powering up or the managed device entering a predetermined location. As another example, the managed devices may be associated with an enterprise, and the enterprise can be an authorized party for receiving reports on operational issues associated with the subset of managed devices.

Another system for receiving operational intelligence for a plurality of managed devices is described herein. The system can include an interface that is configured to receive a report of operational issues associated with a subset of the managed devices in which at least some of the managed devices are configured with different operating environments. The system can also include a management module that is communicatively coupled to the interface. The management module can be configured to—in response to the report of operational issues—execute one or more corrective steps in response to the operational issues associated with the subset of managed devices or to provide instructions to a party to execute one or more corrective steps in response to the operational issues.

In one embodiment, the managed devices may be associated with an enterprise, and the enterprise and the party receiving the execution instructions can be separate entities. In addition, the management module can be configured to execute one or more corrective steps by any of the following: (1) directing one or more of the subset of managed devices to revert back to a previous configuration; (2) provisioning one or more of the subset of managed devices with an upgrade of an operational plan; (3) directing one or more of the subset of managed devices to shift from a first network to a second network or to shift from a first portion of the first network to a second portion of the first network; or (4) restricting the operation of a hardware or software component of one or more of the subset of managed devices.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for providing operational intelligence for managed devices.

FIG. 2 illustrates some of the components of FIG. 1 in exemplary detail.

FIG. 3 illustrates an exemplary method for providing operational intelligence for managed devices.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. An “application” is defined as a program or programs that provide(s) an interface to enable a user to operate a computing device in accordance with one or more particular tasks. The term “operating environment” is defined as a collection of software components that directs a managed device's operations, including controlling and scheduling the execution of other programs and managing storage, input/output and communication resources.

The term “operational intelligence” is defined as information that is associated with the operation of managed devices on an individual, group or global basis (global basis referring to all managed devices that are assigned to or associated with a particular enterprise or organization). A “managed device” is defined as a computing device that is at least partially subject to the control of an enterprise or organization such that the enterprise or organization has the capability to retrieve information from the computing device, send information to the computing device or to cause an action on the computing device to occur. An “operational report” is defined as a collection of information associated with the operation of a managed device in which the information is based on events or actions initiated by a user of the managed device, events and actions initiated by an entity other than the user (including by a machine) or both. The term “operational issue” is defined as a situation, configuration or event, whether currently in existence or possibly in existence in the future, that may affect the operation or performance of one or more managed devices.

An “interface” is defined as a component or group of components that at least receive(s) signals from a first component and transfers those signals to a second component in a form that is compatible with the second component. A “processing unit” is defined as one or more components that execute(s) sets of instructions. The term “storage unit” is defined as one or more components that are configured to store data, either temporarily or persistently. A “display unit” is defined as a component or a group of components that are configured to at least display elements in a form that is perceivable by a human.

As noted earlier, there is a need to provide analytics that are associated with the operation of a plurality of managed devices. Such a process can uncover existing issues and problems that may develop in the future, and steps can be taken to correct them.

To realize a solution, a system and method for providing operational intelligence for managed devices are described herein. The method can include the steps of receiving operational reports from a plurality of managed devices in which the managed devices include devices that have different operating environments and analyzing the operational reports. Based on the analysis of the operational reports, one or more operational issues associated with a subset of the plurality of managed devices can be detected. In addition, corrective action can be taken in response to the detected operational issues.

As such, operational reports for virtually any number of managed devices that are configured with differing operating systems and capabilities can be produced and analyzed. In one embodiment, this analysis can be performed automatically or programmatically. Moreover, these reports can be modified to focus on certain managed devices based on the content installed on the device or the software or hardware components of the device. These features can permit an enterprise to improve the operational performance of its managed devices in a seamless and unobtrusive manner from the end user's perspective. Additionally, the enterprise can be automatically made aware of operational issues without having to conduct expansive and expensive testing procedures.

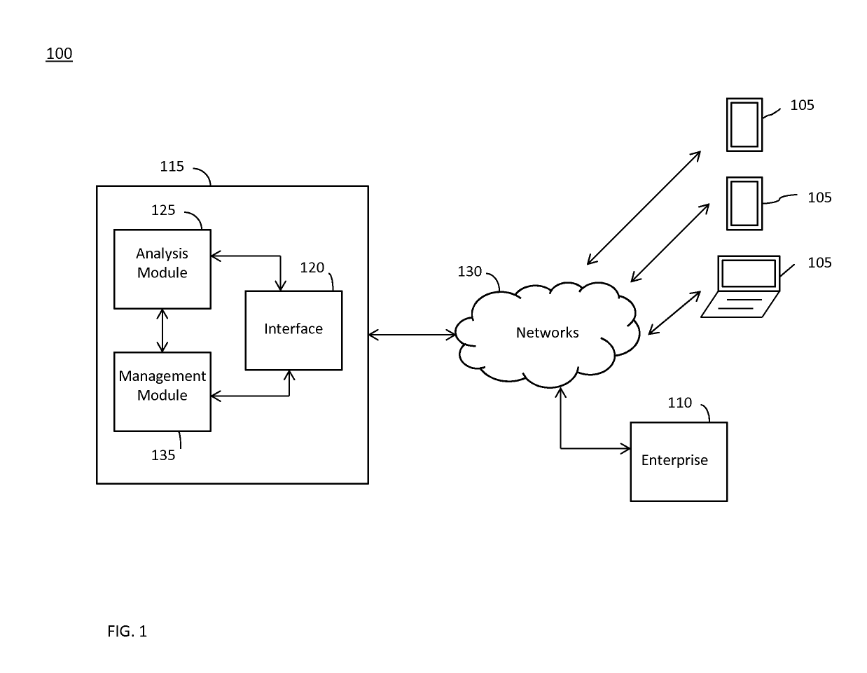

Referring to FIG. 1, an example of a system 100 for providing operational intelligence for managed devices is shown. The system 100 can include a plurality of managed devices 105, which can be assigned to or belong to a plurality of users. As an example, the users can be associated with an enterprise 110, such as a company or other organization, and the enterprise 110 may maintain some control over these managed devices 105. For example, data associated with the enterprise 110 may be stored on or accessible from a managed device 105. In another arrangement, the enterprise 110 may be able to wipe data from a managed device 105 or to block access to certain content during certain times of the day. These principles apply to both managed devices 105 that are provided by the enterprise 110 and managed devices 105 that are owned by a user who may be affiliated with the enterprise in some way.

The managed devices 105 can be any type of computing device, including mobile devices—such as smartphones or laptops—or fixed devices—like desktops or Web-enabled televisions. The managed devices 105 may be configured with different operating environments. For example, some managed devices 105 may be configured to operate with iOS, the mobile operating system provided by Apple, Inc. of Cupertino, Calif. Other managed devices 105, however, may be equipped with Android, a mobile operating system developed by Google, Inc. of Mountain View, Calif. or Windows Mobile, the mobile operating system furnished by Microsoft, Inc. of Redmond, Wash. or other systems. Other ways in which the managed devices 105 may differ in their configurations will be presented below.

The system 100 may also have an operational center 115, which may include an interface 120 and an analysis module 125. The interface 120 can be configured to communicate with a network 130, which can facilitate the exchange of signals between the operational center 115 and the managed devices 105. The network 130 can be any suitable combination of systems for facilitating the exchange of signals between two or more components and can include wired systems, wireless systems or both. Through this arrangement, the enterprise 110 may also be capable of exchanging signals with the operational center 115. In one arrangement, the operational center 115 may also include a management module 135, which may be communicatively coupled to the analysis module 125 and the interface 120. As such, the management module 135 and the analysis module 125 may exchange signals with one another, and the management module 135 may communicate with the managed devices 105 and the enterprise 110 via the network 130. In another arrangement, the enterprise 110 may also include an analysis module (not shown), a management module (not shown) or both. The enterprise 110 may include either of these components in addition to or in lieu of the operational center 115 containing the analysis module 125 and the management module 135.

The party responsible for the operation of the operational center 115 and, hence, the analysis module 125 and the management module 135, may be separate and distinct from the enterprise 110. In another arrangement, the enterprise 110 may be responsible for the operational center 115. As another option, responsibility for the operation of the analysis module 125, the management module 135 or both can be outsourced to any other suitable parties.

In one exemplary summary, the managed devices 105 can provide operational reports to the analysis module 125 of the operational center 115, and the analysis module 125 can analyze these operational reports for any number of operational issues associated with a subset of the managed devices 105. This principle may apply even in the face of all the different configurations that the managed devices 105 may take. In one embodiment, the analysis module 125 can simply report the operational issues to the enterprise 110 or some other authorized party. In response, the enterprise 110 can take corrective steps in response to the reported operational issues. In another embodiment, the analysis module 125 can report the operational issues to the management module 135, which can then take corrective action to resolve them. As another option, both the enterprise 110 can the management module 135 of the operational center 115 can perform the corrective action, with or without coordinating with one another. In either case, problems with a group of a variety of managed devices 105, whether currently in existence or about to develop, can quickly be detected, and corrective measures can be executed in response.

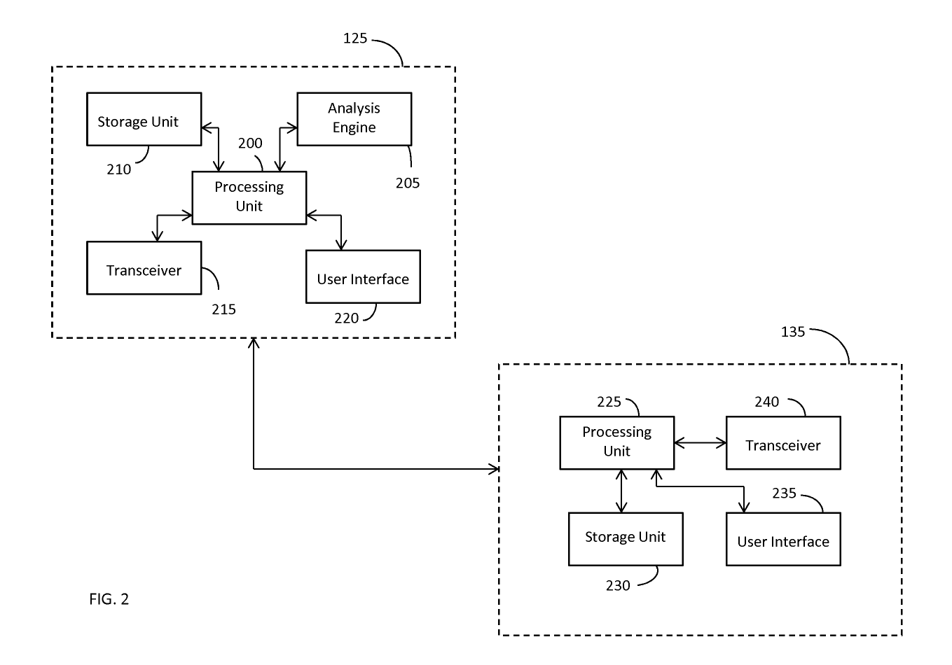

Referring to FIG. 2, block diagrams are presented of the analysis module 125 and the management module 135 of the operational center 115. It must be noted, however, that similar components may also be applicable to and under the control of the enterprise 110 or some other party. In one arrangement, the analysis module 125 can include a processing unit 200, an analysis engine 205, a storage unit 210, a transceiver 215 and a user interface 220. The processing unit 200 can be communicatively coupled to and manage the operation of each of the analysis engine 205, the storage unit 210, the transceiver 215 and the user interface 220. The analysis engine 205 can include any suitable combination of hardware and software components for analyzing operational reports that are received from the managed devices 105 and for detecting operational issues associated with the devices 105, examples of which will be presented below. In one embodiment, the analysis engine 205 can be configured to perform the analysis on a programmatic basis. Thus, the analysis engine 205 can receive numerous operational reports from the managed devices 105 and can automatically spot operational issues related to these devices 105, even before the performance of the devices 105 is hampered. As part of this analysis, the analysis engine 205 can provide an indication as to the actual or most likely cause of an operational issue and can recommend or cause certain actions to be taken to resolve the operational issue.

The storage unit 210 can be used to store any suitable type of data, including that which is necessary for the operation of the processing unit 200, the analysis engine 205, the transceiver 215 or the user interface 220. The transceiver 215 can be configured to forward information about the analysis of the operational reports associated with the managed devices 105 to any suitable component, network or system via a wired or wireless medium. For example, the transceiver 215 can report any operational issues to the management module 135 of the operational center 115 or to the enterprise 110, such as through the network 130. The user interface 220 can be one or more components that enable a user or even another machine to interact with the analysis module 125 and any of its individual parts. Examples of the user interface 220 include standard input/output devices, like keyboards and touch screen displays or conventional displays. In one arrangement, through the user interface 220, a human may monitor, analyze, review or modify the operational reports or any recitations of operational issues, which may be passed on to the management module 135, the enterprise 110 or some other party. As such, the process of providing operational intelligence can be completely automated or may include some human interaction.

The management module 135 can include a processing unit 225, a storage unit 230, a user interface 235 and a transceiver 240, and the processing unit 225 can be communicatively coupled to and mange each of the storage unit 230, the user interface 235 and the transceiver 240. The transceiver 240 can be configured to receive data from the analysis module 125 and to exchange signals with the managed devices 105, the enterprise 110 or both, via the network 130. The storage unit 230, similar to the storage unit 210, can store any suitable type of data, including that needed for the operation of the processing unit 225, the user interface 235 and the transceiver 240. The user interface 235 can be any component or group of components that permit a user or a machine to interact with any of the parts of the management module 135.

In one embodiment, when the management module 135 receives information about any operational issues associated with the managed devices 105, the processing unit 225 (or some other suitable component) can automatically take steps to resolve the issues. Any directives from the processing unit 225 can be forwarded to the managed devices 105 via the transceiver 240. In addition, a user can direct any remedial action to be taken via the user interface 235, which can then be disseminated to any suitable number of the managed devices 105. As noted earlier, a similar arrangement may be achieved at the enterprise 110. Thus, the enterprise 110 can receive information concerning such operational issues and can direct the corrective actions with respect to the managed devices 105. Of course, the management module 135 and the enterprise 110 can work in tandem to handle these responsibilities.

Although the analysis module 125 and the management module 135 have been shown to be contained within the operational center 115, it must be understood that these modules 125, 135 may be located remotely from one another. That is, the modules 125, 135 may be located at the same location and on a common local area network, but such an arrangement is not necessary. For example, the analysis module 125 and the management module 135 may exchange signals over a wide area network and may be operated by separate entities. Indeed, the analysis module 125 may work in combination with a management module (not shown) associated with the enterprise 110 to monitor and respond to operational issues associated with the managed devices 105.

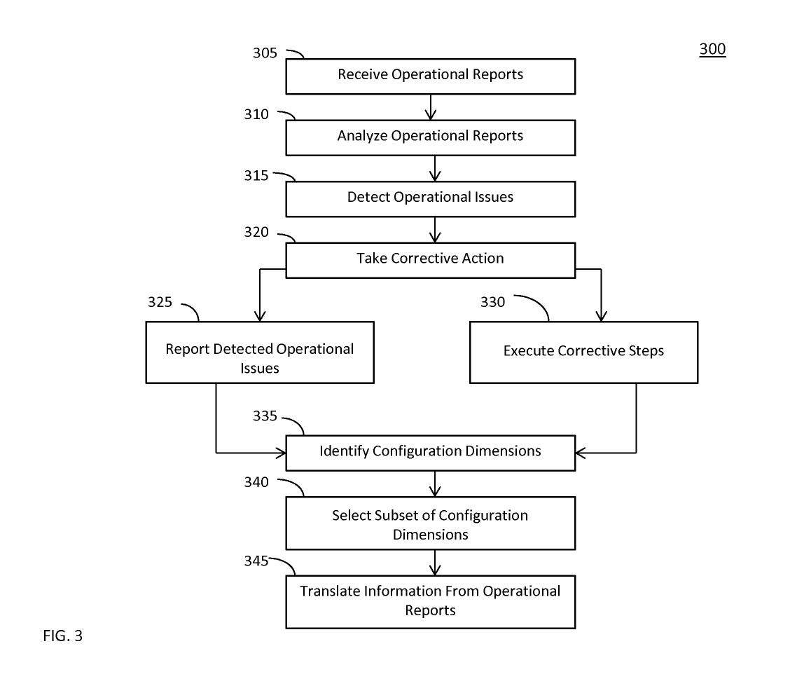

Referring to FIG. 3, a method 300 for providing operational intelligence for managed devices is shown. This method 300 is exemplary in nature, and the steps presented here are not limited to this particular chronological order. Moreover, the method 300 may be practiced with additional steps or with fewer steps in comparison to what is pictured here. References will be made to FIGS. 1 and 2 to explain the method 300, but it is understood that the method 300 can be practiced with other suitable systems and components.

At step 305, operational reports from a plurality of managed devices can be received, and these operational reports can be analyzed, as shown at step 310. Based on the analysis of the operational reports, one or more operational issues associated with a subset of the managed devices can be detected, as shown in step 315. At step 320, corrective action can be taken to at least assist in the alleviation of the detected operational issues.

The corrective action may involve several different alternatives. For example, at step 325, the detected operational issues can be reported. As another example, at step 330, the detected operational issues can be responded to by executing one or more corrective steps. As another alternative, any combination of steps 325 and 330 can be carried out as part of taking corrective action, with varying degrees of focus for either process, as will be explained below.

As part of method 300, a plurality of configuration dimensions associated with the managed devices can be identified, as shown at step 335. A subset of these configuration dimensions can be selected such that the received operational reports are based on the selected subset of configuration dimensions, as shown at step 340. At step 345, information from the operational reports can be translated from one form into another based on an enterprise that is to receive the information from the operational reports.

Detailed examples and explanations in relation to the method 300 will now be presented, with references being made to FIGS. 1 and 2. In one arrangement, the enterprise 110 may be associated with a plurality of managed devices 105. For example, the enterprise 110 may have assigned some of the managed devices 105 to one or more employees or other associates, contractors, etc. As another example, some of the managed devices 105 may belong to employees, associates, contractors, etc. of the enterprise 110, and the enterprise 110 may have some of its content stored on or accessible from the devices 105. In either case, the enterprise 110 may exert some type of control over the managed devices 105, such as by restricting access to certain content, managing individual applications or installing work profiles or work applications.

In view of the possibly thousands of managed devices 105 that may be associated with a particular enterprise 110, the enterprise 110 may wish to monitor the performance of the devices 105 and to take corrective action when necessary. To accommodate such a feature, each or at least some of the managed devices 105 may generate operational reports and forward them to an authorized party, such as the enterprise 110 or the operational center 115.

The operational reports can include virtually any type of information that is related to the operation of the managed devices 105. Here are some non-limiting examples associated with the managed devices 105: (1) data or voice call usage (including distinguishing between multiple users on a single device 105 and isolating certain types of usage, like individual application tracking); (2) network connections and problems with such connections; (3) location tracking; (4) memory usage; (5) status (including failures) of hardware or software components; (6) calendar or scheduled event tracking; (7) application usage, which can include start, stop and idle details; or (8) media storage utilization. Moreover, information related to the operation of the managed device 105 at the time certain events occur may be part of an operational report. For example, the managed device 105 may provide information such as received signal strength, signal quality, battery status, latency of downloads, the particular base station or access point on which the managed device 105 was camped or the status of other components or processes at certain predefined times or based on predefined events. Of course, those skilled in the art will appreciate that there are numerous other examples in relation to the operation of a managed device 105 that may be part of an operational report.

The managed devices 105 can generate and send these operational reports at any suitable time. For example, when the managed devices 105 are initially provisioned by the enterprise 110 or some other entity, a policy can be set that directs a particular managed device 105 to monitor several processes, components or connections and to aggregate this information into an operational report. The policy can also instruct the managed device 105 to transmit the operational report to the relevant part based on a predetermined schedule, like every hour, daily or weekly. To minimize heavy traffic conditions, these schedules may be staggered. As another example, the managed device 105 can be set to provide the operational report based on a predetermined event, such as when the device 105 connects to a predetermined network, when the device 105 powers up or when the device 105 enters a predetermined location. In either case, the predetermined time or predetermined event can be modified at a later time, if desired. For example, the managed device 105 can receive a directive that instructs the device 105 to increase the periodicity with which it transmits operational reports. It is also understood that other components or systems other than the managed devices 105 may generate operational reports.

As noted earlier, the managed devices 105 may include different operating environments, such as dissimilar operating systems. This may be particularly true if some of the managed devices 105 are owned by the employees of the enterprise 110. Moreover, the managed devices 105 may be manufactured by different manufacturers, and even for those built by the same manufacturer, the devices 105 may be different models or disparate versions of the same model. Moreover, some of the managed devices 105 may contain different hardware or software components. For example, some managed devices 105 may have both cellular and Wi-Fi capability, while others may only be designed to operate on a Wi-Fi connection. As another example, some managed devices 105 may be able to conduct video calls, while others may not. In short, in accordance with this description, any type of managed device 105 can be part of a group of managed devices 105 that are to be monitored for operational issues.

Once they generate the operational reports, the managed devices 105 can forward these reports to any suitable entity. In one example, the devices 105 can send the operational reports to the analysis module 125 of the operational center 115. The analysis module 125 can then analyze the operational reports, and based on this analysis, the module 125 may detect one or more operational issues associated with a subset of the managed devices 105. In one arrangement, the analysis module 125 can be configured to detect operational issues on an automated basis, while in another arrangement, one or more humans (or another machine) can analyze the operational reports for operational issues. Of course, a combination of automated and human review can be realized to detect such operational issues.

There are numerous examples of operational issues associated with a subset of the managed devices 105 that may be detected. For example, a certain number of managed devices 105 may be close to reaching data or voice usage thresholds or may have already exceeded such limits In particular, the analysis engine 205 can receive data usage information and compare it to predetermined thresholds, which may be stored in the storage unit 210. As another example, several network connection events can be detected, such as a number of managed devices 105 dropping a network connection or having less than optimal conditions for their connections. As noted earlier, additional operational information may also be received from the managed devices 105, such as received signal strength, signal quality, etc. As such, the operational reports may also provide clues as to why a network connection was poor in quality or simply dropped. In this case, the analysis engine 205 may be able to automatically compare these findings with a mapping of a particular network to help focus on a particular component or section of that network that may be causing the problem. A user of the analysis module 125 may also review some of the operational reports and may provide input in some form to help explain the detected issue.

In yet another example, several managed devices 105 may have had a particular hardware or software component fail. Other examples of detected operational issues associated with a subset of managed devices 105 may include the following: (1) an inadequate operational or service plan, particularly for a certain location; (2) malware or other harmful content; or (3) a particular application that is causing problems, like heavy traffic conditions on a network; or (4) per application resource consumption, such as CPU, storage and memory utilization. One skilled in the art will appreciate that the examples listed above are not meant to be limiting. In fact, virtually any type and number of operational issues can be detected from the operational reports received from the managed devices 105.

In one particular arrangement, a root cause analysis may be part of the analysis of the operational reports. Specifically, the analysis module 125 may attempt to determine the exact cause or the most probable cause of a particular operational issue. As an option, if there are several conditions that may be the cause of an operational issue, the root cause analysis may recite each one and may provide a percentage with each one that designates the probability that that particular condition is causing the operational issue. Additional description as to how the analysis module may perform a root cause analysis will be presented below.

It must be noted that the detected operational issue may be an operational issue that currently exists or one that has a probability of existing in the future. Consider the example above in relation to data usage. Some of the managed devices 105 may have data limits (certain amount of data over a period of time, usually a month). As an example, a subset of the managed devices 105 may have already exceeded their data usage limits This operational issue can be said to be currently in existence. In contrast, the operational reports may reveal that several managed devices 105 are approaching but have not yet exceeded their data usage limits. Here, the operational issue is characterized by having a probability of existing at a future time, as the affected devices 105 may indeed exceed these limits based on past usage or other relevant factors.

The description above refers to a subset of managed devices 105 having one or more operational issues. A subset of managed devices 105 associated with an enterprise may indeed refer to a number that is less than all the managed devices 105 associated with that enterprise. Nevertheless, a subset of managed devices 105 may include all managed devices 105 associated with an enterprise. The composition of a subset of managed devices 105 depends on the type of operational issues that are being detected. For example, if all the managed devices 105 of an enterprise have exceeded data usage limits, then the subset of managed devices 105 should include all the managed devices 105. Moreover, a subset can be as low as a single managed device 105.

As explained so far, an operational issue may be a degradation in the performance of a subset of managed devices 105. That is, there may be some condition that is affecting or has affected a number of managed devices 105 in a negative way. It must be noted, however, that an operational issue is not necessarily limited to a degradation in performance. For example, the analysis module 125 may determine that better than expected performance has been realized for a certain number of managed devices 105. As a more specific example, the module 125 may detect that a subset of managed devices 105 receive better than average or exceptional signal strength or stable network connections in a particular location. As another example, some managed devices 105 may report a certain software or hardware configuration that is set when the devices 105 avoid exceeding data usage limits, which may also be detected by the analysis module 125. The analysis for this particular feature can be the same as described above in that the analysis module 125 can detect these desirable operational issues and possibly provide an analysis (such as a root cause analysis) as to why they exist.

Once operational issues are detected, corrective action can be taken in response to them. For example, the analysis module 125 can report the operational issues to some relevant system, component or party, such as the management module 135, the enterprise 110 or some other authorized entity. The reporting of these operational issues may be contained in an analysis report. There are multiple examples of operational issues associated with the operation of a subset of managed devices 105 that may be reported, some of which are listed as follows: (1) the reaching or anticipated reaching of a data usage limit; (2) network connection events; (3) recommending a shift in network assignments; (4) a predicted impact on the operation of a subset of managed devices if a predetermined course of action is to be followed; (5) pending scheduled events that may affect operations of a managed device; or (6) a root cause analysis that identifies one or more problems, configurations or events as the root cause of the detected operation issues. Any combination of these examples may be reported. For example, a network connection event may be reported, along with a root cause analysis that identifies the source (or most likely source) of the issue. It must also be understood that these are non-limiting examples, as other findings may be reported.

Additional explanations of some of these examples will now be presented. In one arrangement, the encroachment on data usage limits may identify which particular managed devices 105 or configurations of the managed devices 105 are affected or most affected. As a more specific example, the analysis report from the analysis module 125 may include a root cause analysis that shows that managed devices 105 that are loaded with a particular application are typically in danger of exceeding data usage limits In another embodiment, the reporting of network connection events may include, for example, dropped connections, poor connections or connections that may be deemed better than average or optimal. As an example, this reporting may also flag which network or network component is the source of the reported operational issue.

As another example, if a network or network component is discovered to be the source of an operational issue, the analysis report may include a recommendation that the managed devices 105 switch or shift to a different network. This recommendation may include, for example, a suggested shift to the services of another wireless carrier with better network coverage or service plan or to direct managed devices 105 to avoid a particular access point.

As mentioned above, the analysis report may also provide an indication as to how a course of action would affect the operation of managed devices 105 if implemented. For example, the enterprise 110 or some other entity may wish to add a number of managed devices 105 under its control. To determine how such a step may affect the overall operation of the existing managed devices 105 and/or their networks, the enterprise 110 or some other suitable entity may generate an operational report and forward the report to the analysis module 125. This operational report may include information related to the changes proposed by the enterprise 110. Once received, the analysis module 125 may run simulations to detected potential operational issues with the existing managed devices 105. For example, assuming the entity 110 wishes to add a substantial number of managed devices 110 to its inventory, the analysis module 125 can determine how such a change may affect the network connections—in terms of dropped or slower connections—of the existing devices 105 and the additional expenses to be incurred by the entity 110. Further, the analysis module 125 may access historical data (which can be retrieved from the storage unit 210) that is related to previous operational cycles of the managed devices 105 as part of its analysis. Any potential operational issues detected by the analysis module 125 can be reported to the enterprise 110. Of course, there are numerous other potential changes that can be analyzed in accordance with this description, along with their predicted impacts. As an option, the analysis module 125 may also provide to the enterprise 110 suggestions to possibly improve or limit the predicted impact.

The type of events and the granularity of the reporting described above may be modified to enable higher or lower levels of detail in the analysis reports. For example, an enterprise 110 may wish to limit the type of events in the analysis reports that it receives to network connection issues related to the operation of its managed devices 105. Moreover, the enterprise 110 may further wish to limit the network connection issue to dropped connections only. As another example, the granularity of the reporting can be magnified to provide additional details for the enterprise 110 concerning the dropped connection. For example, the enterprise 110 may wish to learn which particular component of the network caused the issue, such as a particular base station or access point, and the operating status (e.g., signal strength, signal quality, etc.) of the affected managed devices 105. Of course, the detail provided can be reduced, if the enterprise 110 does not find it necessary. In either case, the entity to which the analysis reports are provided can control the type of events and their granularity in such reports.

As previously explained, operational reports are not limited to being generated by the managed devices 105. An example above noted how an enterprise 110 may provide an operational report to determine how a certain action would possibly affect the performance of existing devices 105. In one embodiment, the analysis module 125 may also receive operational reports from the networks on which the managed devices 105 are operating. For example, in response to a dropped connection, a base station or access point may note one or more of its operating details at the time of the drop, such as load, traffic capacity, any hardware or software failures, etc. Similar to the managed devices 105, the network may also generate an operational report and provide it to the analysis module 125. In another embodiment, the analysis module 125 can request an operational report or some other relevant information from the appropriate network, such as through a secure gateway.

Simply reporting information about operational issues has been described as part of taking corrective action to respond to an operational issue. Taking corrective action may also include taking active steps to resolve such an issue. That is, taking corrective action may also include the enterprise 110, the management module 135 or some other suitable entity executing one or more steps to resolve the reported issue. There are multiple examples of such corrective steps, and some of them are as follows: (1) directing one or more of the subset of managed devices 105 to revert back to a previous configuration; (2) provisioning one or more of the subset of managed devices 105 with an upgrade of an operational plan; (3) directing one or more of the subset of managed devices 105 to shift from a first network to a second network or to shift from a first portion of the first network to a second portion of the first network; (4) restricting the operation of a hardware of software component of one or more of the subset of managed devices 105; or (6) directing another party to carry out corrective steps.

Consider the following scenario. A number of managed devices 105 may have been provisioned with new content, such as a new policy or a new application. Analysis reports from the analysis module 125 may indicate that this new content is the most likely culprit of operational issues that have negatively affected the performance of the affected managed devices 105. In response, the enterprise 110, the management module 135 or some other entity can signal the managed devices 105 to return to the configuration that was in place prior to the receipt of the new content. In some cases, this may involve the devices 105 simply deleting the new content, although more complex actions may be executed. Once this process is carried out, additional monitoring of the managed devices 105 may be conducted to determine if the issue has been resolved.

Consider another scenario. The enterprise 110 may discover that a large number of managed devices 105 are exceeding or are about to exceed data usage limits In response, the enterprise 110 or the management module 135 can take actions to upgrade the operational or service plans of the affected devices 105. In one embodiment, these upgraded plans may have been previously negotiated with a wireless carrier and may be automatically implemented at the choice of the enterprise 110 or module 135. In another example, as noted above, an operational report may indicate that a scheduled event related to one or more managed devices 105 is upcoming The analysis module 125 may review the scheduled event and make the determination that it warrants a service plan upgrade. In particular, it may be determined that several users of a subset of managed devices 105 have calendar entries for travel to a foreign country. To avoid steep roaming charges, the enterprise 110 or the management module 135 can implement an upgraded service plan to accommodate the travel. This process could also be carried out in response to obtaining the physical location of one or more managed devices 105, if it is determined that the current service plans for these devices 105 is insufficient for the determined location.

In another example, an analysis report may show that there is consistent trouble with a network or a portion of a network. In response, the enterprise 110 or the management module 135 may direct the affected managed devices 105 to shift to a different network or to another part of the troubled network. For instance, the analysis report may have identified a particular Wi-Fi network as having consistent dropped connections for a number of managed devices 105. To alleviate the connection issues, the enterprise 110 or the management module 135 may direct the managed devices 105 to connect with another Wi-Fi network or a wide area network. As another example, the analysis report may also indicate that a particular network component, such as a base station or an access point, is the source of the operational issue. As such, the enterprise 110 or the management module 135 can blacklist the faulty component by instructing the managed devices 105 to avoid using it. As part of this process, the enterprise 110 or the management module 135 can instruct the affected managed devices 105 to substitute the blacklisted network component with another suitable component. Such redirecting information may be initially obtained from the analysis report provided by the analysis module 125.

As noted earlier, the analysis report may show that a certain hardware or software component of the managed devices 105 is leading to the detected operational issue(s). For example, the analysis report may provide a root cause analysis that shows that a particular application is most likely causing several managed devices 105 to exceed data usage limits or to experience delayed download speeds or dropped connections. In response, the enterprise 110 or the management module 135 may direct the managed devices 105 to uninstall the application. Similarly, if a hardware component is the source, the managed devices 105 may be directed to avoid using the hardware component, if possible. As part of this process, the analysis report may make recommendations that provide alternatives to the source of the operational issues, which the enterprise 110 or the module 135 may take the steps necessary to implement the recommendations.

In the examples described above, either the enterprise 110 or the management module 135 may take direct action in response to the operational issues. In another arrangement, the enterprise 110 or the management module 135 may direct some other party to take such corrective steps. For example, the enterprise 110, once it learns of an operational issue (and possibly a recommended alternative), may direct the management module 135 to carry out specific steps in response to the detected issue. Of course, the enterprise 110 may also direct other suitable parties to handle this procedure. If any party performs a corrective action on behalf of an authorizing party, the performing party may notify the authorizing party following the corrective action or prior to initiating the action to get permission to take such action. For example, the management module 135 may receive permission from the enterprise 110 prior to taking corrective action on behalf of the enterprise 110.

As explained above, the granularity of an analysis report can be modified, depending on the level of detail desired by the party receiving the report. In another arrangement, a similar process can be conducted with respect to the operational reports that are generated by the managed devices 105. In particular, a number of configuration dimensions associated with a plurality of managed devices 105 can be identified, and a subset of the configuration dimensions can be selected such that the received operational reports are based on the selected subset of configuration dimensions.

A configuration dimension can be any particular arrangement or grouping of the characteristics associated with the operation of a managed device 105 that can be used to focus or narrow the monitoring of such devices 105. Configuration dimensions may be based on some of the following examples: (1) content installed on the managed devices 105; (2) device types of the managed devices 105; (3) hardware or software configurations of the managed devices 105; (4) network connections of the managed devices 105; or (5) locations of the managed devices 105. It is understood, however, that there are other examples of configuration dimensions, and the description is not limited to the ones recited here.

Through the strategic use of configuration dimensions, the monitoring of a plurality of managed devices 105 may be narrowed down to certain devices 105 with one or more common characteristics. For example, the enterprise 110 or some other suitable party may wish to focus operational reports and analysis reports on managed devices 105 produced by a certain manufacturer or operating on a particular operating system. As another example, the enterprise 110 may wish to focus on managed devices 105 that have one or more particular applications installed on them or that include certain hardware components, like video cameras. In still yet another example, the operational and analysis reports can be crafted to focus on managed devices 105 that have access to certain networks or have a likelihood of being in a certain location over the course of a time period.

The number and type of selected configuration dimensions can be modified at any suitable time. In this manner, an enterprise 110 or other party can quickly focus on certain configurations/settings that may lead to a greater number of operational issues and can take remedial actions, if needed. This type of analysis can also reveal that certain configurations/settings are producing improved operations of the managed devices 105. In another arrangement, the selection of configuration dimensions may also be applicable to the generation of an analysis report. For example, the operational reports may be received from a large number of managed devices 105, but during the analysis of such reports, the analysis module 125 may be able to focus on certain managed devices 105 by selecting certain configuration dimensions, similar to the process described above. That is, the analysis reports from the analysis module 125 may be based on a selection of a subset of configuration dimensions. As such, configuration dimensions can be selected to better focus both operational reports and analysis reports.

In one arrangement, the operational center 115 may be responsible for a large number of managed devices 105, many of which are assigned to different enterprises 110. Thus, the analysis module 125 may need to provide information to enterprises 110 that have different formats for the receipt of such information. For example, a first enterprise 110 may wish to receive analysis reports that show data usage averaged over a weekly basis, while a second enterprise 110 may prefer the average to be over a monthly basis. Assuming the operational reports that come in from the managed devices 105 show data usage averaged over a monthly period, the analysis module 125 can translate this data to weekly average for the first enterprise in the analysis report for that enterprise 110. Other translations for other measurements or data in the analysis reports can be conducted.

In another embodiment, the corrective action taken can be escalated. For example, if the analysis module 125 generates and sends an analysis report to the enterprise 110 but the enterprise 110 does not respond. The module 125 may take some action to address any operational issues in the analysis report. Moreover, if a first corrective action does not solve an operational issue, additional steps may be carried out. For example, a first corrective action may be to direct a number of managed devices 105 to avoid a particular access point. If subsequent monitoring shows that the managed devices 105 are still having problems, a stronger corrective action can be taken by, for example, directing the managed devices 105 to begin using a different network. Another way that corrective actions may be escalated includes sending analysis reports to additional entities, which can enable such entities to provide input to help solve a particular operational issue.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the claims and their equivalents should not be limited by any of the above-described exemplary embodiments.

What is claimed is:

1. A method for providing operational intelligence for managed devices, comprising:
receiving operational reports from a plurality of managed devices, wherein the managed devices include devices that have different operating environments;
analyzing the operational reports;
based on the analysis of the operational reports, detecting one or more operational issues associated with a subset of the plurality of managed devices; and
taking corrective action in response to the detected operational issues.

2. The method according to claim 1, wherein detecting one or more operational issues comprises detecting currently existing operational issues or detecting operational issues that have a probability of existing at a future time.

3. The method according to claim 2, wherein the operational issue is a degradation in the performance of the subset of managed devices.

4. The method according to claim 1, wherein taking corrective action comprises reporting the detected operational issues or responding to the detected operational issues by executing one or more corrective steps.

5. The method according to claim 4, wherein reporting the detected operational issues comprises:
reporting a data usage limit associated with the operation of the subset of managed devices;
reporting network connection events associated with the operation of the subset of managed devices;
reporting a recommended shift in network assignments for the subset of managed devices;
reporting a predicted impact on the operation of the subset of managed devices if a predetermined course of action is to be followed;
reporting pending scheduled events that may affect operations of a managed device; or
reporting a root cause analysis that identifies one or more problems, configurations or events as the root cause of the detected operational issues.

6. The method according to claim 4, wherein executing one or more corrective steps comprises:
directing one or more of the subset of managed devices to revert back to a previous configuration;
provisioning one or more of the subset of managed devices with an upgrade to an operational plan;
directing one or more of the subset of managed devices to shift from a first network to a second network or to shift from a first portion of the first network to a second portion of the first network;
restricting the operation of a hardware or software component of one or more of the subset of managed devices; or
directing another party to execute one or more corrective steps.

7. The method according to claim 1, further comprising:
identifying a plurality of configuration dimensions associated with the plurality of managed devices; and
selecting a subset of the configuration dimensions such that the received operational reports are based on the selected subset of configuration dimensions.

8. The method according to claim 5, wherein the configuration dimensions are based on content installed on the plurality of managed devices, device types of the plurality of managed devices, hardware or software configurations of the plurality of managed devices, a network connection of the plurality of managed devices or a location of the plurality of managed devices.

9. The method according to claim 1, further comprising translating information from the operational reports from one form into another based on an enterprise that is to receive the information from the operational reports.

10. The method according to claim 1, wherein receiving operational reports from the plurality of managed devices comprises receiving the operation reports based on a predetermined schedule or a predetermined event.

11. The method according to claim 10, wherein the predetermined event is a managed device being connected to a predetermined network, the managed device powering up or the managed device entering a predetermined location.

12. A method for providing operational intelligence for managed devices, comprising:
identifying a plurality of managed devices that are associated with an enterprise, wherein at least some of the managed devices are configured with different operating environments;
receiving operational reports from the managed devices;
analyzing the operational reports;
based on the analysis of the operational reports, detecting one or more operational issues associated with a subset of the plurality of managed devices; and
reporting the operational issues to the enterprise.

13. The method according to claim 12, further comprising:
identifying a plurality of configuration dimensions associated with the plurality of managed devices; and
selecting a subset of the configuration dimensions such that the received operational reports are based on the selected subset of configuration dimensions, wherein the reported operational issues are related to the selected subset of configuration dimensions.

14. A method for providing operational intelligence for managed devices, comprising:
identifying a plurality of managed devices, wherein at least some of the managed devices are configured with different operating environments;
receiving operational reports from the managed devices;
analyzing the operational reports;
based on the analysis of the operational reports, detecting one or more operational issues associated with a subset of the plurality of managed devices; and
responding to the detected operational issues by executing one or more corrective steps.

15. The method according to claim 14, wherein the managed devices are associated with an enterprise and the method further comprises reporting the operational issues and the corrective steps to the enterprise.

16. The method according to claim 15, further comprising receiving permission from the enterprise to execute the corrective steps.

17. The method according to claim 14, further comprising:
identifying a plurality of configuration dimensions associated with the plurality of managed devices; and
selecting a subset of the configuration dimensions such that the received operational reports are based on the selected subset of configuration dimensions, wherein the reported operational issues are related to the selected subset of configuration dimensions.

18. A method of receiving operational intelligence for managed devices, comprising:
receiving a report of operational issues associated with a subset of a plurality of managed devices, wherein at least some of the managed devices are configured with different operating environments;
in response to the report of operational issues, executing one or more corrective steps to resolve the operational issues associated with the subset of managed devices or providing instructions to a party to execute one or more corrective steps to resolve the operational issues.

19. The method according to claim 18, wherein the managed devices are associated with an enterprise, and the enterprise and the party are separate entities.

20. The method according to claim 18, wherein executing one or more corrective steps comprises:
directing one or more of the subset of managed devices to revert back to a previous configuration;
provisioning one or more of the subset of managed devices with an upgrade of an operational plan;
directing one or more of the subset of managed devices to shift from a first network to a second network or to shift from a first portion of the first network to a second portion of the first network; or
restricting the operation of a hardware or software component of one or more of the subset of managed devices.

21. A system for providing operational intelligence for managed devices, comprising:
an interface, wherein the interface is configured to receive operational reports from a plurality of managed devices, wherein at least some of the managed devices are configured with different operating environments;
an analysis module that is communicatively coupled to the interface, wherein the analysis module is configured to:
analyze the operational reports;
based on the analysis of the operational reports, detect one or more operational issues associated with a subset of the plurality of managed devices; and
report the operational issues to one or more authorized parties.

22. The system according to claim 21, further comprising a management module, wherein the management module is configured to execute one or more corrective steps in response to the reported operational issues.

23. The system according to claim 21, wherein the operational issues that are detected are currently existing operational issues or operational issues that have a probability of existing at a future time.

24. The system according to claim 23, wherein the operational issue is a degradation in the performance of the subset of managed devices.

25. The system according to claim 21, wherein the analysis module is further configured to report the operational issues by:
reporting a data usage limit associated with the operation of the subset of managed devices;
reporting network connection events associated with the operation of the subset of managed devices;
reporting a recommended shift in network assignments for the subset of managed devices;
reporting a predicted impact on the operation of the subset of managed devices if a predetermined course of action is to be followed;
pending scheduled events that may affect operations of a managed device; or
reporting a root cause analysis that identifies one or more problems, configurations or events as the root cause of the detected operational issues.

26. The system according to claim 22, wherein the management module is further configured to execute the corrective steps by:
directing one or more of the subset of managed devices to revert back to a previous configuration;
provisioning one or more of the subset of managed devices with an upgrade to an operational plan;
directing one or more of the subset of managed devices to shift from a first network to a second network or to shift from a first portion of the first network to a second portion of the first network;
restricting the operation of a hardware or software component of one or more of the subset of managed devices; or
directing another party to execute one or more corrective steps.

27. The system according to claim 21, wherein the analysis module is further configured to:
identify a plurality of configuration dimensions associated with the plurality of managed devices; and
select a subset of the configuration dimensions such that the received operational reports are based on the selected subset of configuration dimensions.

28. The system according to claim 27, wherein the configuration dimensions are based on content installed on the plurality of managed devices, device types of the plurality of managed devices, hardware or software configurations of the plurality of managed devices, a network connection of the plurality of managed devices or a location of the plurality of managed devices.

29. The system according to claim 21, wherein the operational reports are received from the managed devices based on a predetermined schedule or a predetermined event.

30. The system according to claim 29, wherein the predetermined event is a managed device being connected to a predetermined network, the managed device powering up or the managed device entering a predetermined location.

31. The system according to claim 21, wherein the managed devices are associated with an enterprise and the enterprise is an authorized party for receiving reports on operation issues associated with the subset of managed devices.

32. A system for receiving operational intelligence for a plurality of managed devices, comprising:
an interface that is configured to receive a report of operational issues associated with a subset of the managed devices, wherein at least some of the managed devices are configured with different operating environments; and
a management module that is communicatively coupled to the interface, wherein the management module is configured to—in response to the report of operational issues—execute one or more corrective steps in response to the operational issues associated with the subset of managed devices or to provide instructions to a party to execute one or more corrective steps in response to the operational issues.

33. The system according to claim 32, wherein the managed devices are associated with an enterprise and the enterprise and the party receiving the execution instructions are separate entities.

34. The system according to claim 32, wherein the management module is configured to execute one or more corrective steps by:
directing one or more of the subset of managed devices to revert back to a previous configuration;
provisioning one or more of the subset of managed devices with an upgrade of an operational plan;
directing one or more of the subset of managed devices to shift from a first network to a second network or to shift from a first portion of the first network to a second portion of the first network; or
restricting the operation of a hardware or software component of one or more of the subset of managed devices.
